(19) United States
(12) Patent Application Publication
(10) Pub. No.: US 2024/0241973 A1
(43) Pub. Date: Jul. 18, 2024

(54) SECURITY TECHNIQUES FOR SHARED USE OF ACCELERATORS

(71) Applicants: Aditya Katragada, Austin, TX (US); Andrew Cunningham, Ennis (IE); Ramesh Babu Bodakunta, Marlborough, MA (US); Gary Brian Wallichs, San Jose, CA (US)

(72) Inventors: Aditya Katragada, Austin, TX (US); Andrew Cunningham, Ennis (IE); Ramesh Babu Bodakunta, Marlborough, MA (US); Gary Brian Wallichs, San Jose, CA (US)

(21) Appl. No.: 18/621,950

(22) Filed: Mar. 29, 2024

(51) Int. Cl. G06F 21/60

(52) U.S. Cl. CPC G06F 21/606

(57) ABSTRACT

Systems or methods of the present disclosure may provide techniques for securing data on a shared accelerator of an integrated circuit device where each user of the shared accelerator is in a different trust boundary. For example, a method may include receiving a downstream communication intended for an accelerator from one or more components sharing the accelerator, determining an origin component from which the downstream communication originated, and assigning the downstream communication to a corresponding work queue of one or more work queues of the accelerator based on the determined origin component to isolate the accelerator from different owners. The method may also include tagging an upstream communication sent from the accelerator with an identifier that identifies the owner of the data and routing the upstream communication to a destination component based on the identifier and using the assigned attributes to isolate data within or external to the accelerator.

### BACKGROUND

The present disclosure relates generally to integrated circuit devices. More particularly, the present disclosure relates to securing communications between components of an integrated circuit device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuit devices may include various components, such as memory devices, programmable logic blocks, and processors. Further, programmable logic, such as a field-programmable gate array (FPGA) of an integrated circuit device may include one or more accelerators (e.g., hardware accelerators) that each perform a specific function for hardware and/or software components of the integrated circuit device. To perform a specific function for a component, an accelerator may interface with other functions of an FPGA. For example, an accelerator may utilize and/or communicate with other programmable logic of the FPGA to generate one or more cryptographic keys for a processing unit. However, shared communications with multiple components by the accelerator may expose the multiple components to security vulnerabilities. Thus, techniques to isolate communications between components using the accelerator as a shared resource may be desired.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of programmable fabric of the integrated circuit device of FIG. 1, in accordance with an embodiment of the present disclosure;

FIG. 4 is a block diagram of the integrated circuit device of FIG. 1 including an accelerator, in accordance with an embodiment of the present disclosure;

FIG. 5 is a block diagram of the integrated circuit device of FIG. 1 in which access control components are initiated, in accordance with an embodiment of the present disclosure;

FIG. 6 is a block diagram of the integrated circuit device of FIG. 1 in which downstream communications are routed to an accelerator, in accordance with an embodiment of the present disclosure;

FIG. 7 is a block diagram of the integrated circuit device of FIG. 1 in which upstream communications are routed to components of the integrated circuit device, in accordance with an embodiment of the present disclosure;

FIG. 8 is a flow chart of a method for securing components using an accelerator of a programmable logic device as a shared resource, in accordance with an embodiment of the present disclosure; and

FIG. 9 is a is a block diagram of a data processing system including the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned, programmable logic of an integrated circuit (IC) device may include one or more accelerators (e.g., hardware accelerators), and each accelerator may perform a specific function to aid a processor in performing the specific function. In particular, an accelerator may perform the specific function independently from the processor and/or more efficiently than another hardware or software component of an IC device and, thus, the component may instruct (e.g., drive) the accelerator to perform the function as needed. Further, to perform certain functions, such as generating and exchanging cryptographic keys, the accelerator may accept certain requests, operands, and parameters from a component, and the programmable logic may grant access to resources accessible by the accelerator, such as memory or programmable logic of an FPGA. However, granting such unrestricted access may lead to trust boundary violations, privileging challenges, and the like between components sharing use of the accelerator.

The present systems and techniques relate to embodiments for securing communications between components that share use of an accelerator of an integrated circuit device. In particular, embodiments of the present disclosure may include downstream access control circuitry that may determine a component from which a downstream communication originated and direct the communication to an appropriate work queue of the accelerator. As used herein, downstream communications may include control signals, transaction attempts, and the like sent from a component to an accelerator. Embodiments of the present disclosure may also include upstream access control circuitry that redirects an output of an accelerator work queue to a recipient component based on qualities of the output. As used herein, upstream communications may include communications sent from the accelerator to a component (e.g., a destination component). Additionally, embodiments of the present disclosure may include resource allocator circuitry that may dynamically or statically tag upstream and downstream communications within the accelerator with identifiers that may be utilized by the downstream access control circuitry and the upstream access control circuitry. The downstream access control circuitry and the upstream access control circuitry may be included as part of an accelerator wrapper that contains the accelerator, which may allow the downstream access control circuitry and the upstream access control circuitry to intercept communications between the accelerator and connected components. Further, embodiments of the present disclosure may include a request buffer, an operand buffer, and a response buffer that may be part of programmable logic of the integrated circuit device.

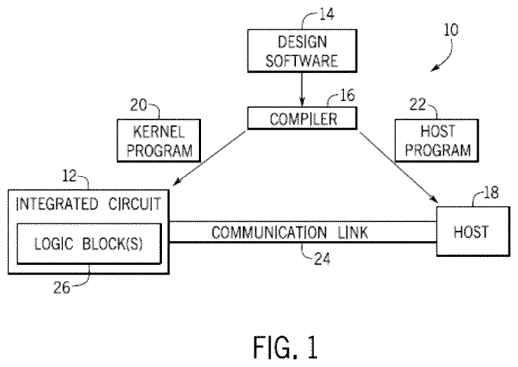

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL®, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of one or more logic circuitry 26 on the integrated circuit device 12. The logic circuitry 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

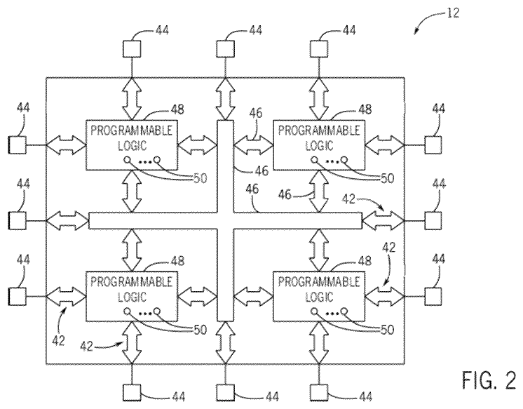

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation and/or application-specific standard product). The integrated circuit device 12 may have input/output circuitry 42 for driving signals off the device and for receiving signals from other devices via input/output pins 44. Interconnection resources 46, such as global and local vertical and horizontal conductive lines and buses, and/or configuration resources (e.g., hardwired couplings, logical couplings not implemented by designer logic), may be used to route signals on integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

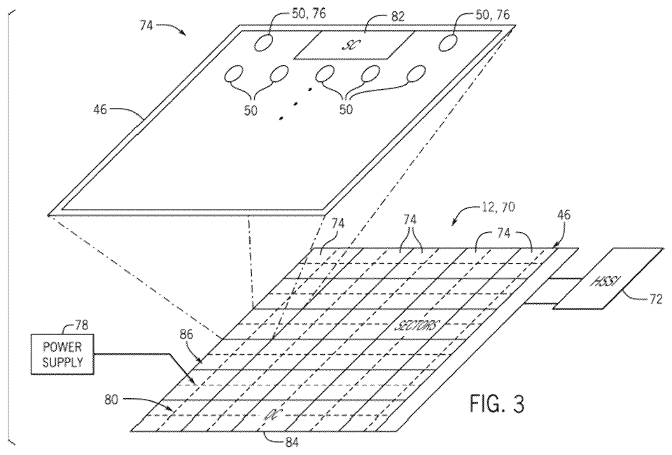

The integrated circuit device 12 may include any programmable logic device such as a field programmable gate array (FPGA) 70, as shown in FIG. 3. For the purposes of this example, the FPGA 70 is referred to as a FPGA, though it should be understood that the device may be any suitable type of programmable logic device (e.g., an application-specific integrated circuit and/or application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and Designer Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable elements 50 having operations defined by configuration memory 76 (e.g., CRAM). A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sectors 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable element 50 or programmable component of the interconnection resources 46. The output signals of the configuration memory 76 may be applied to the gates of metal-oxide-semiconductor (MOS) transistors that control the states of the programmable elements 50 or programmable components of the interconnection resources 46.

The programmable elements 50 of the FPGA 40 may also include some signal metals (e.g., communication wires) to transfer a signal. In an embodiment, the programmable logic sectors 74 may be provided in the form of vertical routing channels (e.g., interconnects formed along a y-axis of the FPGA 70) and horizontal routing channels (e.g., interconnects formed along an x-axis of the FPGA 70), and each routing channel may include at least one track to route at least one communication wire. If desired, communication wires may be shorter than the entire length of the routing channel. That is, the communication wire may be shorter than the first die area or the second die area. A length L wire may span L routing channels. As such, a length of four wires in a horizontal routing channel may be referred to as “H4” wires, whereas a length of four wires in a vertical routing channel may be referred to as “V4” wires.

As discussed above, some embodiments of the programmable logic fabric may be configured using indirect configuration techniques. For example, an external host device may communicate configuration data packets to configuration management hardware of the FPGA 70. The data packets may be communicated internally using data paths and specific firmware, which are generally customized for communicating the configuration data packets and may be based on particular host device drivers (e.g., for compatibility). Customization may further be associated with specific device tape outs, often resulting in high costs for the specific tape outs and/or reduced scalability of the FPGA 70.

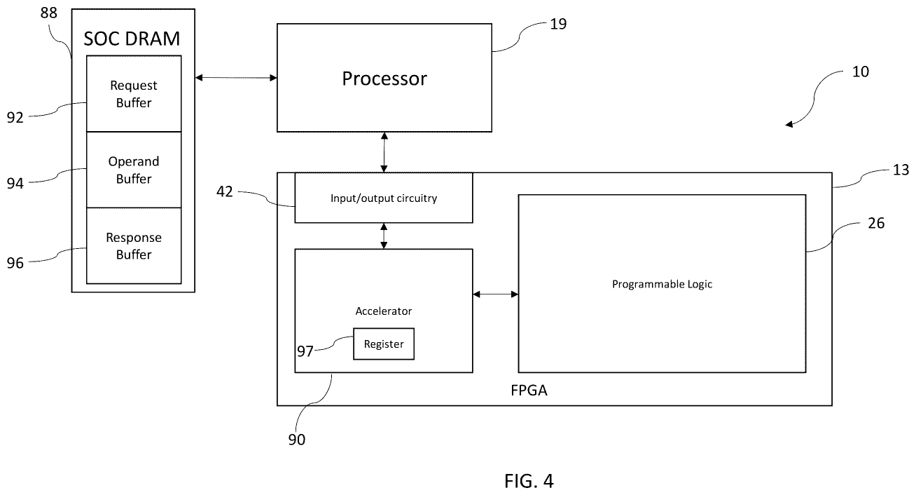

FIG. 4 is a block diagram of the system 10 including an FPGA 13, which may represent the integrated circuit device 12 of FIGS. 1-3, and a processor 19, which may represent the host 18 of FIGS. 1-3, in accordance with an embodiment. As illustrated, the FPGA 13 includes the logic circuitry 26 and input/output circuitry 42, which may include, for example, a PCIe controller that provides a communication link between the processor 19 and components of the FPGA 13. In addition, the FPGA 13 may include a accelerator 90 which may include circuitry (e.g., logic circuitry 26) and may be configured to implement a specific operation or function for other portions of the logic circuitry 26 and/or the processor 19. In particular, the processor 19 may communicate instructions from a host program to the accelerator 90 via a communications link facilitated by the input/output circuitry 42. Additionally, the accelerator 90 may communicate with the logic circuitry 26 to perform specific functions or operations for the system 10. Further, the accelerator may, via communication with the processor 19 and/or the logic circuitry 26, access memory elements of the processor 19 and/or the logic circuitry 26 to perform the specific functions or operations. It should be noted that while one processor 19 is illustrated, in some embodiments, multiple processors 19 may communicate instructions to the accelerator 90 and/or the logic circuitry 26 via the input/output circuitry 42. Further, the processor 19 may execute multiple host programs that may each communicate instructions to the accelerator 90. That is, one or more processors 19, one or more host programs of the one or more processors 19, and/or the logic circuitry 26 may communicate with the accelerator 90 as a shared resource of the system 10.

As mentioned, to implement a specific operation, the accelerator 90 may read and write from one or more memory devices, such as a dynamic random-access memory (DRAM) 88 managed by the processor 19. For example, to implement a cryptographic key exchange operation (e.g., of a transport layer security (TLS) protocol), a host program executed by the processor 19 may initialize a request buffer 92, an operand buffer 94, and a response buffer 96, each of which may include one or more memory cells that may store data. The host program may then copy one or more operands of the cryptographic key exchange operation to the operand buffer 94. Additionally, the host program may copy a descriptor to the request buffer 92, and the descriptor may describe and/or indicate the cryptographic key exchange operation.

The host program of the processor 19 may then send, via the input/output circuitry 42, a pointer (e.g., a downstream communication) to a register 97 of the accelerator 90. The register 97 may be part of a work queue of the accelerator 90 that corresponds to the host program. Indeed, the accelerator 90 may have multiple work queues, each having one or more of such registers 97, and each work queue may correspond to a hardware or software component of the integrated circuit device 12, which will be described in detail below. In any case, the pointer may point to the request buffer 92 and may cause the accelerator 90 to fetch the descriptor stored in the request buffer 92 via a direct memory access (DMA) operation (e.g., an upstream communication). The descriptor may include, for example, a command for the accelerator 90 to execute, such as a cryptographic key operation. Additionally, the descriptor may include a pointer to the operand buffer 94 and may cause the accelerator 90 to fetch the operands stored in the operand buffer 94. Logic circuitry of the accelerator 90, such as elliptic curve cryptography circuitry, may then execute an operation based on the command and the operands. Upon completion of the operation, the accelerator 90 may write an output of the operation, such as a cryptographic key, a signed message, or the like to the response buffer 96. The accelerator 90 may then send an interrupt to the input/output circuitry 42. In response to the interrupt, the input/output circuitry 42 may fetch the output from the response buffer 96 and may send the output to the processor 19. Additionally or alternatively, the processor 19 may monitor the response buffer 96 for completion of the operation (e.g., the presence of an output in the response buffer 96) and subsequently fetch the output via a read operation of the response buffer 96.

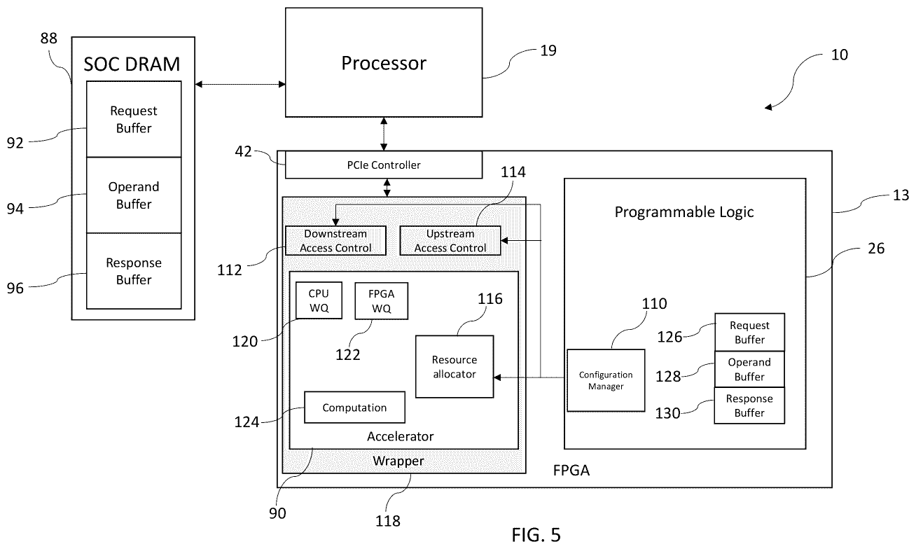

FIG. 5 is a block diagram of the system 10 of FIG. 4, in which a configuration manager 110 of the logic circuitry 26 initializes downstream access control circuitry 112, an upstream access control circuitry 114, and a resource allocator 116. As used herein, the downstream access control circuitry 112, the upstream access control circuitry 114, and/or the resource allocator 116 may include hard-wired circuitry and/or software to control access to components of the system 10. For example, the downstream access control circuitry 112 may include downstream access control circuitry, and the upstream access control circuitry 114 may include upstream access control circuitry. Additionally, in the illustrated embodiment, the logic circuitry 26 may include a local request buffer 126, a local operand buffer 128, and a local response buffer 130 implemented in soft logic, such as programmable elements that form memory cells. As will be described below, the local request buffer 126, the local operand buffer 128, and the local response buffer 130 may be used for or subject to additional access control measures implemented by the logic circuitry 26. The accelerator 90 may include computation circuitry 124 that includes logic circuitry that performs a specific operation of the accelerator 90, such as a computation function that produces a computation output, generation, determination, or the like. For example, the computation circuitry 124 may produce an elliptic curve cryptography output based on commands and operands received via the processor work queue 120 or the FPGA work queue 122 that may each include one or more registers 97.

The configuration manager 110 may include configuration management hardware, such as a device controller and/or sector controller (e.g., the device controller 84 or the sector controller 82 of FIG. 3) that may send configuration settings to (e.g., initialize) the downstream access control circuitry 112, the upstream access control circuitry 114, and the resource allocator 116. The configuration settings may include a quantity of work queues, routing conditions, identifiers, and the like. For example, the configuration settings may instruct the upstream access control circuitry 114 to redirect upstream operand requests to the processor 19 or the logic circuitry 26 based on whether an identifier of the upstream operand request is associated with the processor 19 or the logic circuitry 26. These configuration settings may be adjusted by a user of the integrated circuit device 12 and/or the FPGA 13. For example, the configuration manager 110 may send the configuration settings based on a configuration file (e.g., bitstream), and the configuration file may be adjusted via a host program of the processor 19, as described above.

Further, the downstream access control circuitry 112 and the upstream access control circuitry 114 may include hard-wired circuitry and may be included as part of a wrapper 118 that may intercept and/or redirect communication packets sent to the accelerator 90 from, for example, the input/output circuitry 42 and/or the logic circuitry 26. Additionally or alternatively, the downstream access control circuitry 112 and/or the upstream access control circuitry 114 may be implemented in soft logic of the FPGA 13. The configuration manager 110 may program a programmable element of interconnection resources (e.g., the interconnection resources 46 of FIG. 2) to redirect certain signals being sent to the accelerator 90, for instance.

In the illustrated embodiment, the configuration manager 110 may initialize the downstream access control circuitry 112 such that it may determine a component from which a communication originated and, based on the determined component, route the communication to a corresponding work queue of the accelerator 90. As illustrated, the accelerator 90 may include a processor work queue 120 that corresponds to the processor 19 and an FPGA work queue 122 that corresponds to the logic circuitry 26. As may be appreciated, the accelerator 90 may include any suitable number of work queues (e.g., 1, 5, 10, 20, or 100 work queues) that correspond to one or more hardware or software components that may use the accelerator 90 as a shared resource. In an example, the processor 19 may implement a rich execution environment (REE) with a corresponding REE work queue and a trusted execution environment (TEE) with a corresponding TEE work queue. Further, a user of the system 10 may, via instructions to the configuration manager 110, change a security configuration of the accelerator 90. For example, a user may, via the processor 19, alter a bitstream used by the configuration manager 110 to change work queue allocations, information applied to communications by the resource allocator 116, and so on.

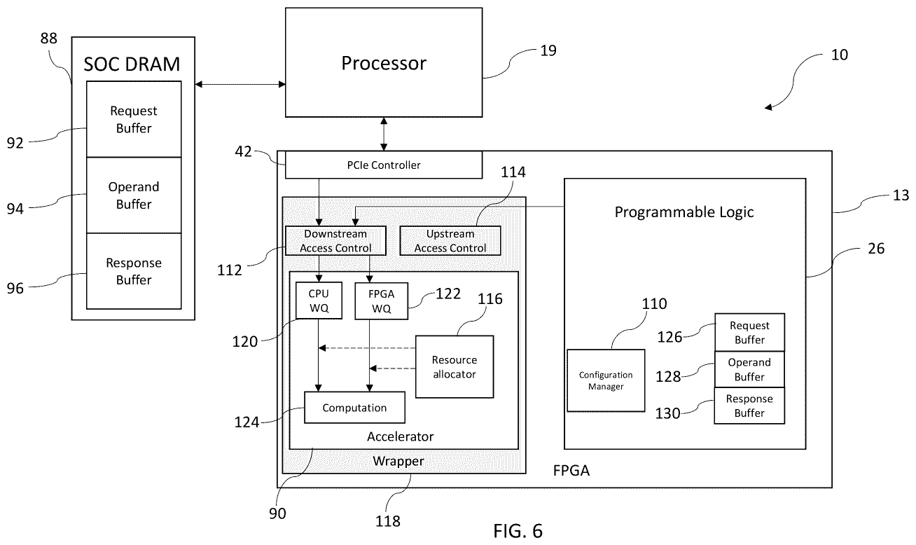

FIG. 6 is a block diagram of the system 10 in which the downstream access control circuitry 112 receives and routes downstream communications from hardware and/or software components to a corresponding work queue of the accelerator 90. As mentioned, the downstream access control circuitry 112 may determine a corresponding work queue to send each communication based on a determination of an origin device. The origin device of a received communication may be determined based on, for example, input/output pin(s) the communication is received on, which may be determined by the input/output circuitry 42, the device controller 84 of FIG. 3, or other suitable components of the FPGA 13. Additionally or alternatively, communications originating from hardware and/or software components may include indications of the origin device according to networking protocols, and the downstream access control circuitry 112 may determine an origin device based on the indications. In the illustrated embodiment, the downstream access control circuitry 112 may send communications that originate from the processor 19 to the processor work queue 120 and may send communications that originate from the logic circuitry 26 to the FPGA work queue 122. As may be appreciated, this correspondence between components and work queues may mitigate an attempt from one component to access the work queue of another component.

In some embodiments, the system 10 may include multiple downstream access control circuitries implemented hierarchically. For example, the downstream access control circuitry 112 may determine a corresponding secondary downstream access control circuitry to send each communication based on the determination of the origin device. The corresponding secondary downstream access control circuitry may then determine a corresponding work queue to send the received communication based on the determination of the origin device or another suitable determination. In some cases, corresponding secondary downstream access control circuitry may determine a corresponding tertiary downstream access control circuitry to send the received communication to, and the corresponding tertiary downstream access control circuitry may determine a corresponding work queue to send the received communication to. Indeed, the system 10 may include any suitable number (e.g., 5, 10, 100) of successive downstream access control circuitry levels according to an access control scheme.

In the illustrated embodiment, the processor work queue 120 and the FPGA work queue 122 may send communications, such as commands and operands, to the computation circuitry 124. In some embodiments, the resource allocator 116 may attach an identifier to the communications before they are received by the computation circuitry 124. For example, the resource allocator 116 may alter the communications from the processor work queue 120 to include an indication that the communication was sent by the processor work queue 120.

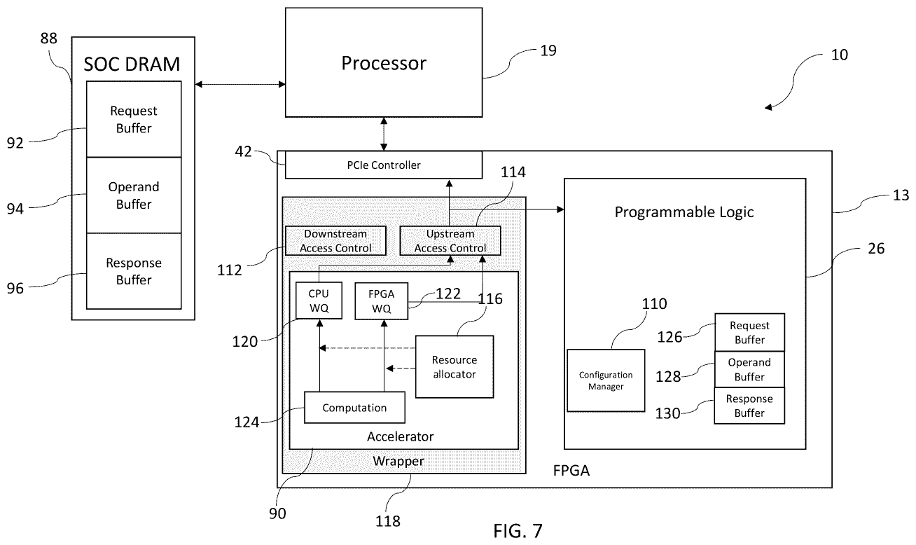

FIG. 7 is a block diagram of the system 10 in which upstream communications are evaluated and redirected to a component (e.g., destination component, target component) based on identifiers included with the upstream communications. As used herein, upstream communications may include, for example, operands, fetches, requests, responses, and access requests (e.g., to access memory of a component) related to a function of the accelerator 90. In the illustrated embodiment, the resource allocator 116 may tag upstream communications with identifiers and other programmable attributes. The identifiers may be based on one or more work queue characteristics, such as a type of communication between the accelerator 90 and other components. For example, communications including operands, responses, operand requests, and/or response requests may be tagged with an identifier indicating the logic circuitry 26, and communications including descriptors and/or descriptor requests may be tagged with an identifier indicating the processor 19. Based on the identifier, the upstream access control circuitry 114 may route the communication from the processor work queue 120 or the FPGA work queue 122 to the logic circuitry 26 or the processor 19 (e.g., via the input/output circuitry 42).

In some embodiments, the system 10 may include multiple upstream access control circuitries implemented hierarchically. For example, the upstream access control circuitry 114 may determine a corresponding secondary upstream access control circuitry to send each communication based on the identifier. The corresponding secondary upstream access control circuitry may then determine a component to send the received communication based on the identifier or another attribute of the communication. In some cases, the secondary corresponding upstream access control may determine a corresponding tertiary upstream access control circuitry to send the received communication to, and the corresponding tertiary upstream access control circuitry may determine a component to send the received communication to. Indeed, the system 10 may include any suitable number (e.g., 5, 10, 100) of successive upstream access control circuitry levels according to an access control scheme.

The programmable attributes may be used by a software or hardware component for further access control functions and may include an access control attribute, such as a privilege level. For example, an upstream communication may include an identifier of the logic circuitry 26, and may thus be routed to the logic circuitry 26. The upstream communication may also include a programmable attribute indicating a privilege level of the processor 19, and the logic circuitry 26 may, in response, restrict access of the upstream communication to certain regions in which the processor 19 is allowed access. For example, upstream communications with a privilege level of the processor 19 may only be permitted to cause a read or write of the local operand buffer 128 and the local response buffer 130 that correspond to the processor 19, and may be restricted from accessing other local operand buffers, local response buffers, or local request buffers. As such, the processor 19 may maintain access to necessary functions of the logic circuitry 26 via the accelerator 90, such as fetching operands and responses stored in the logic circuitry 26, but access to other portions of the logic circuitry 26 by the processor 19 may be restricted.

The manner by which communications are tagged may be adjusted by changing configuration settings managed by the configuration manager 110. For example, to change a privilege level that governs access within the logic circuitry 26 for communications originating from the processor 19, the configuration manager 110 may instruct the resource allocator 116 to tag upstream communications associated with the processor work queue 120 with a different privilege level. Likewise, to change a privilege level that governs access within the DRAM 88 for communications originating from the logic circuitry 26, the configuration manager 110 may instruct the resource allocator 116 to tag upstream communications associated with the FPGA 13 with a different privilege level. As such, security configuration settings that may define trust domains, privilege levels, and the like between devices may be adjusted as desired via the configuration manager 110. Further, it should be noted that, while the DRAM 88 is illustrated and described as being managed by the processor 19, the techniques described herein may be additionally or alternatively performed in conjunction with a DRAM associated with the FPGA 13.

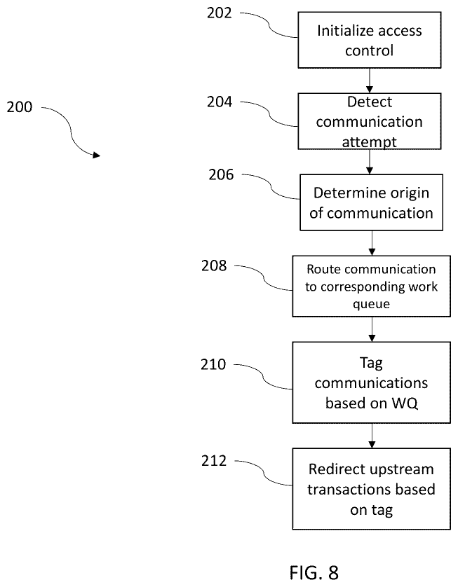

FIG. 8 is a flow chart of a method 200 for securing components using an accelerator 90 of a programmable logic device (e.g., integrated circuit 12, FPGA 13) as a shared resource. The method 200 may begin, in block 202, with initializing access control for communications with the accelerator 90. For example, the FPGA 13 may include a configuration manager 110 that may send configuration settings to a resource allocator (e.g., the resource allocator 116), downstream access control circuitry (e.g., the downstream access control circuitry 112), and upstream access control circuitry (e.g., the upstream access control circuitry 114). The configuration settings may include trust domain characteristics, privilege levels, and the like. For example, configuration settings sent to the downstream access control circuitry 112 may include instructions to send communications from a particular component to a particular work queue of the accelerator 90, configuration settings sent to the resource allocator 116 may include instructions to tag certain communications with an identifier, and configuration settings sent to the upstream access control circuitry 114 may include instructions to send upstream communications with a particular identifier to a particular device.

In block 204, an attempt to communicate with the accelerator 90 is detected. Communications may originate from a hardware or software component, such as the processor 19, a rich execution environment (REE) of the processor 19, a trust execution environment (TEE) of the processor 19, or logic circuitry of the FPGA 13, as examples. The communication may include, for example, a request or command for the accelerator to perform a specific function, such as generating one or more cryptographic keys. Further, the communication may be detected by the downstream access control circuitry 112 within a wrapper of the accelerator 90, and may be received via the input/output circuitry 42, which, as mentioned, may include a PCIe controller. In block 206, the origin component of the communication attempt is determined by the input/output circuitry 42 and/or the downstream access control circuitry 112. The origin component of the communication attempt may be determined based on, for example, an input/output port(s) at which the communication is received, an identifier included with the communication (e.g., as part of a networking protocol), or the like.

Based on the determined origin component of the communication and/or configuration settings of the downstream access control circuitry, in block 208, the communication is routed to a corresponding work queue by the downstream access control circuitry 112. The accelerator 90 may, for example, include a work queue (e.g., the processor work queue 120 and the FPGA work queue 122) for each of one or more devices using the accelerator 90 as a shared resource, and the work queues may be initialized by the configuration manager (e.g., in block 202). Each work queue may, for example, send communications, such as operands, commands, and the like to a computation component of the accelerator 90 and may receive an output from the computation component. The work queues may operate concurrently, which may allow for the accelerator 90 to perform a specific operation and/or communicate with multiple components simultaneously. Further, because a separate work queue may handle operations and communications for each component, components may be isolated from accessing communications associated with other devices.

In block 210, communications within the accelerator 90 may be tagged by the resource allocator 116 with identifiers and/or programmable attributes based on work queue characteristics. Work queue characteristics may include a type or content of communication, such as operands, requests, commands, and the like, an origin component, and/or a target component. For example, an upstream communication may be tagged with an identifier indicating the processor 19 and an indication that the communication includes instructions to fetch a descriptor from DRAM 88 of the processor 19. The resource allocator 116 may tag the communications by, for example, appending data (e.g., a tag) on the communications, and aspects of the tagging, such as types of identifiers and/or programmable attributes to tag communications with, which communications to tag, and so on may be adjusted by the configuration manager 110 of the FPGA 13, as described herein.

In block 212, the upstream access control circuitry 114 may route (e.g., control access of) communications to one or more components based on the tag applied to the communications in block 210. Additionally, components to which communications are routed to may be based on configuration settings applied to the upstream access control block in block 202. For example, the configuration settings may instruct the upstream access control circuitry 114 to route communications including an identifier indicating the processor 19 to the DRAM 88 of the processor 19, to route communications including an identifier indicating the FPGA 13 to logic circuitry 26 of the FPGA 13, and so on. Additionally, as described herein, attributes included with the communications (e.g., as applied to the communications in block 210) may include access control attributes, and the access control attributes may be used by components that receive the communications. For example, an access control attribute of an upstream communication sent to logic circuitry 26 of the FPGA 13 may include a privilege level of the processor 19, and the FPGA 13 may only allow communication access to regions of the logic circuitry 26 with appropriate privilege levels including the request buffer 126, the operand buffer 128, and/or the response buffer 130.

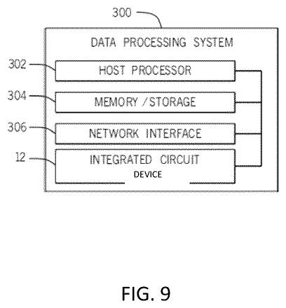

Bearing the foregoing in mind, the integrated circuit device 12 may be a component included in a data processing system, such as a data processing system 300, shown in FIG. 9. The data processing system 300 may include the integrated circuit device 12 (e.g., a programmable logic device), a host processor 304 (e.g., a processor), memory and/or storage circuitry 306, and a network interface 308. The data processing system 300 may include more or fewer components (e.g., electronic display, designer interface structures, ASICs). Moreover, any of the circuit components depicted in FIG. 9 may include integrated circuits (e.g., integrated circuit device 12). The host processor 304 may include any of the foregoing processors that may manage a data processing request for the data processing system 300 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 306 may include random access memory (RAM), read-only memory (ROM), one or more hard drives, flash memory, or the like. The memory and/or storage circuitry 306 may hold data to be processed by the data processing system 300. In some cases, the memory and/or storage circuitry 306 may also store configuration programs (bit streams) for programming the integrated circuit device 12. The network interface 308 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. For instance, components of the data processing system 300 may be located in separate geographic locations or areas, such as cities, states, or countries.

In one example, the data processing system 300 may be part of a data center that processes a variety of different requests. For instance, the data processing system 300 may receive a data processing request via the network interface 308 to perform encryption, decryption, machine learning, video processing, voice recognition, image recognition, data compression, database search ranking, bioinformatics, network security pattern identification, spatial navigation, digital signal processing, or some other specialized task.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A method, comprising: receiving a downstream communication, at a programmable logic device, intended for an accelerator; determining, via the programmable logic device, an origin component of one or more components from which the downstream communication originated; assigning, via the programmable logic device, the downstream communication to a corresponding work queue of a plurality of work queues of the accelerator based on the determined origin component to isolate data from remaining components of the one or more components; tagging, via the programmable logic device, an upstream communication sent from the accelerator with attributes to maintain isolation of the data between owners of the plurality of work queues; and routing, via the programmable logic device, the upstream communication to a destination component based on the attributes.

EXAMPLE EMBODIMENT 2. The method of example embodiment 1, wherein the downstream communication comprises a request for the accelerator to perform a computation function.

EXAMPLE EMBODIMENT 3. The method of example embodiment 2, wherein the computation function comprises a cryptographic computation function.

EXAMPLE EMBODIMENT 4. The method of example embodiment 1, wherein the one or more components comprise programmable logic of a field-programmable gate array (FPGA).

EXAMPLE EMBODIMENT 5. The method of example embodiment 1, wherein the one or more components comprise a processor.

EXAMPLE EMBODIMENT 6. The method of example embodiment 1, wherein the one or more components comprise one or more software components.

EXAMPLE EMBODIMENT 7. The method of example embodiment 6, wherein the one or more software components comprise a rich execution environment (REE) of a processor and a trusted execution environment (TEE) of the processor.

EXAMPLE EMBODIMENT 8. The method of example embodiment 1, wherein the attributes include an indication of the origin component.

EXAMPLE EMBODIMENT 9. The method of example embodiment 1, wherein the upstream communication comprises a computation output of the accelerator.

EXAMPLE EMBODIMENT 10. The method of example embodiment 1, wherein the programmable logic device comprises hardened logic circuitry configured to: assign the downstream communication to the corresponding work queue of the plurality of work queues of the accelerator based on the determined origin component to isolate data from the remaining components of the one or more components; tag the upstream communication sent from the accelerator with the attributes to maintain isolation of the data between the owners of the plurality of work queues; and route the upstream communication to the destination component based on the attributes.

EXAMPLE EMBODIMENT 11. A system, comprising: an accelerator comprising: one or more work queues; and wrapper circuitry communicatively connected to the accelerator, comprising: downstream access control circuitry configured to: receive a communication intended for the accelerator; determine an origin component of the communication; and route the communication to a work queue of the one or more work queues of the accelerator; and upstream access control circuitry configured to: receive an additional communication from the one or more work queues, wherein the additional communication comprises an identifier; and route the additional communication to a target component based on the identifier.

EXAMPLE EMBODIMENT 12. The system of example embodiment 11, wherein the accelerator comprises a resource allocator configured to tag the additional communication with the identifier and one or more programmable attributes.

EXAMPLE EMBODIMENT 13. The system of example embodiment 12, comprising a programmable logic component comprising a configuration manager configured to send one or more configuration settings to the downstream access control circuitry, the upstream access control circuitry, and the resource allocator.

EXAMPLE EMBODIMENT 14. The system of example embodiment 13, wherein the resource allocator is configured to tag the additional communication with the identifier and the one or more programmable attributes based on the one or more configuration settings.

EXAMPLE EMBODIMENT 15. The system of example embodiment 13, wherein the origin component comprises the programmable logic component.

EXAMPLE EMBODIMENT 16. The system of example embodiment 13, wherein the target component comprises the programmable logic component, and wherein the programmable logic component is configured to: restrict the additional communication from accessing first programmable logic based on the one or more programmable attributes; and allow the additional communication to access second programmable logic based on the one or more programmable attributes.

EXAMPLE EMBODIMENT 17. A tangible, non-transitory, and computer-readable medium, storing instructions thereon, wherein the instructions, when executed, are to cause a first processor to: receive a downstream communication intended for an accelerator; determine whether the downstream communication is sent from a second processor or from programmable logic of a field-programmable gate array (FPGA); assign the downstream communication to a first work queue or a second work queue of one or more work queues of the accelerator based on the determination; receive an upstream communication comprising an identifier corresponding to the first work queue or the second work queue; and route the upstream communication to the second processor or the programmable logic of the FPGA based on the identifier.

EXAMPLE EMBODIMENT 18. The tangible, non-transitory, and computer-readable medium of example embodiment 17, wherein the upstream communication comprises one or more access control attributes.

EXAMPLE EMBODIMENT 19. The tangible, non-transitory, and computer-readable medium of example embodiment 18, wherein the upstream communication comprises an access request, and wherein the FPGA is configured to restrict the access request based on the one or more access control attributes.

EXAMPLE EMBODIMENT 20. The tangible, non-transitory, and computer-readable medium of example embodiment 18, wherein the upstream communication comprises an access request, and wherein the second processor is configured to restrict the access request based on the one or more access control attributes.

What is claimed is:

1. A method, comprising:
receiving a downstream communication, at a programmable logic device, intended for an accelerator;
determining, via the programmable logic device, an origin component of one or more components from which the downstream communication originated;
assigning, via the programmable logic device, the downstream communication to a corresponding work queue of a plurality of work queues of the accelerator based on the determined origin component to isolate data from remaining components of the one or more components;
tagging, via the programmable logic device, an upstream communication sent from the accelerator with attributes to maintain isolation of the data between owners of the plurality of work queues; and
routing, via the programmable logic device, the upstream communication to a destination component based on the attributes.

2. The method of claim 1, wherein the downstream communication comprises a request for the accelerator to perform a computation function.

3. The method of claim 2, wherein the computation function comprises a cryptographic computation function.

4. The method of claim 1, wherein the one or more components comprise programmable logic of a field-programmable gate array (FPGA).

5. The method of claim 1, wherein the one or more components comprise a processor.

6. The method of claim 1, wherein the one or more components comprise one or more software components.

7. The method of claim 6, wherein the one or more software components comprise a rich execution environment (REE) of a processor and a trusted execution environment (TEE) of the processor.

8. The method of claim 1, wherein the attributes include an indication of the origin component.

9. The method of claim 1, wherein the upstream communication comprises a computation output of the accelerator.

10. The method of claim 1, wherein the programmable logic device comprises hardened logic circuitry configured to:
assign the downstream communication to the corresponding work queue of the plurality of work queues of the accelerator based on the determined origin component to isolate data from the remaining components of the one or more components;
tag the upstream communication sent from the accelerator with the attributes to maintain isolation of the data between the owners of the plurality of work queues; and
route the upstream communication to the destination component based on the attributes.

11. A system, comprising:
an accelerator comprising:
one or more work queues; and
wrapper circuitry communicatively connected to the accelerator, comprising:
downstream access control circuitry configured to:
receive a communication intended for the accelerator;
determine an origin component of the communication; and
route the communication to a work queue of the one or more work queues of the accelerator; and
upstream access control circuitry configured to:
receive an additional communication from the one or more work queues, wherein the additional communication comprises an identifier; and
route the additional communication to a target component based on the identifier.

12. The system of claim 11, wherein the accelerator comprises a resource allocator configured to tag the additional communication with the identifier and one or more programmable attributes.

13. The system of claim 12, comprising a programmable logic component comprising a configuration manager configured to send one or more configuration settings to the downstream access control circuitry, the upstream access control circuitry, and the resource allocator.

14. The system of claim 13, wherein the resource allocator is configured to tag the additional communication with the identifier and the one or more programmable attributes based on the one or more configuration settings.

15. The system of claim 13, wherein the origin component comprises the programmable logic component.

16. The system of claim 13, wherein the target component comprises the programmable logic component, and wherein the programmable logic component is configured to:
restrict the additional communication from accessing first programmable logic based on the one or more programmable attributes; and
allow the additional communication to access second programmable logic based on the one or more programmable attributes.

17. A tangible, non-transitory, and computer-readable medium, storing instructions thereon, wherein the instructions, when executed, are to cause a first processor to:
receive a downstream communication intended for an accelerator;
determine whether the downstream communication is sent from a second processor or from programmable logic of a field-programmable gate array (FPGA);
assign the downstream communication to a first work queue or a second work queue of one or more work queues of the accelerator based on the determination;
receive an upstream communication comprising an identifier corresponding to the first work queue or the second work queue; and
route the upstream communication to the second processor or the programmable logic of the FPGA based on the identifier.

18. The tangible, non-transitory, and computer-readable medium of claim 17, wherein the upstream communication comprises one or more access control attributes.

19. The tangible, non-transitory, and computer-readable medium of claim 18, wherein the upstream communication comprises an access request, and wherein the FPGA is configured to restrict the access request based on the one or more access control attributes.

20. The tangible, non-transitory, and computer-readable medium of claim 18, wherein the upstream communication comprises an access request, and wherein the second processor is configured to restrict the access request based on the one or more access control attributes.
